(19) United States
(12) Patent Application Publication
(10) Pub. No.: US 2013/0067383 A1
(43) Pub. Date: Mar. 14, 2013

(54) USER GESTURES INDICATING RATES OF EXECUTION OF FUNCTIONS

(71) Applicants: Satoshi Kataoka, Tokyo (JP); Ken Wakasa, Tokyo (JP)

(72) Inventors: Satoshi Kataoka, Tokyo (JP); Ken Wakasa, Tokyo (JP)

(73) Assignee: Google Inc., Mountain View, CA (US)

(21) Appl. No.: 13/249,197

(22) Filed: Sep. 29, 2011

Related U.S. Application Data
(63) Continuation of application No. 13/228,245, filed on Sep. 8, 2011.

(51) Int. Cl. G06F 3/048

(52) U.S. Cl. 715/773

(57) ABSTRACT

Aspects of this disclosure are directed to receiving, by a computing device having one or more processors and a presence-sensitive interface, an indication of a first user gesture to select an icon of a graphical keyboard displayed by the presence-sensitive interface, and receiving, by the computing device, an indication of a second user gesture that indicates a rate of execution of a function associated with the selected icon. The computing device may execute the function associated with the selected icon at an execution rate based on the indicated rate of execution.

This application is a continuation of U.S. application Ser. No. 13/228,245, filed Sep. 8, 2011, the entire contents of which are incorporated herein by reference.

### TECHNICAL FIELD

This disclosure relates to computing devices and, more particularly, to the execution of functions of the computing devices.

### BACKGROUND

Computing devices may perform various functions, such as displaying image content such as documents, e-mails, and pictures on a screen. Computing devices may accept a user input and perform one or more functions in response to receiving the user input. For example, the computing device may include a presence-sensitive interface, such as a presence-sensitive display. The computing device may, in some examples, cause the presence-sensitive display to display one or more selectable icons, such as icons of a graphical keyboard.

The computing device may receive a user input for the selection of an icon displayed by the presence-sensitive display. In response to receiving the user input, the computing device may perform one or more functions associated with the selected icon. For instance, a user may select a character key of a graphical keyboard displayed by the presence-sensitive display by touching a portion of the presence-sensitive display that is associated with the displayed character key. In response, the computing device may cause the presence-sensitive display to display the character associated with the selected character key, such as in a word processing or other application executing on one or more processors of the computing device.

### SUMMARY

In one example, this disclosure describes a method performed by a computing device having one or more processors and a presence-sensitive interface that includes receiving, by the computing device, an indication of a first user gesture to select an icon of a graphical keyboard displayed by the presence-sensitive interface of the computing device. The method further includes receiving, by the computing device, an indication of a second user gesture that indicates a rate of execution of a function associated with the selected icon, and executing, by the computing device, the function associated with the selected icon at an execution rate based on the indicated rate of execution.

In another example, this disclosure describes a computer-readable storage medium that includes instructions that, if executed by a computing device having one or more processors and a presence-sensitive interface, cause the computing device to perform a method that includes receiving, by the computing device, an indication of a first user gesture to select an icon of a graphical keyboard displayed by the presence-sensitive interface of the computing device, receiving, by the computing device, an indication of a second user gesture that indicates a rate of execution of a function associated with the selected icon, and executing, by the computing device, the function associated with the selected icon at an execution rate based on the indicated rate of execution.

In another example, this disclosure describes a computing device that includes one or more processors, and a presence-sensitive interface operable to display a graphical keyboard having one or more selectable icons, receive an indication of a first user gesture to select an icon of the graphical keyboard displayed by the presence-sensitive interface, and receive an indication of a second user gesture that indicates a rate of execution of a function associated with the selected icon. The computing device further includes instructions, that if executed by the one or more processors, cause the computing device to determine a rate of the indicated rate of execution, and to perform the function associated with the selected icon at an execution rate based on the determined rate of the indicated rate of execution.

Aspects of this disclosure may provide one or more advantages. For instance, the techniques of this disclosure may allow a computing device to change the rate of execution of a function associated with an icon displayed by a presence-sensitive interface of the computing device. As one example, a user of the computing device may not need to repeatedly select the icon to execute the function associated with the icon. In addition, the user may not need to continuously select the icon while the computing device repeatedly executes a function associated with the icon at a default rate of repeated execution. Rather, the user may provide a gesture that indicates a rate of execution of a function associated with the selected icon, and the computing device may execute the function associated with the selected icon at an execution rate based on the indicated rate of execution.

The details of one or more aspects of this disclosure are set forth in the accompanying drawings and the description fellow. Other features, objects, and advantages of the disclosure will be apparent from the description and drawings, and from the claims.

### BRIEF DESCRIPTION OF DRAWINGS

FIG. 1 is a block diagram illustrating an example computing device for reception of a an indication of a user gesture and the performance of a function associated with a selected icon at an execution rate based on a rate of execution indicated by the user gesture, in accordance with one or more aspects of this disclosure.

FIG. 2 is a block diagram illustrating an example computing device, in accordance with one or more aspects of this disclosure.

FIG. 3 is a flow chart illustrating an example operation of a computing device, in accordance with one or more aspects of this disclosure.

FIG. 4 is a flow chart illustrating another example operation of a computing device, in accordance with one or more aspects of this disclosure.

FIG. 5 is a flow chart illustrating another example operation of a computing device, in accordance with one or more aspects of this disclosure.

### DETAILED DESCRIPTION

Examples described in this disclosure are directed to techniques that may enable a user to change the rate of execution of a function associated with an icon of a graphical keyboard displayed by a presence-sensitive interface of a computing device. For example, the computing device may be a cellular telephone. The cellular telephone may include a presence-sensitive interface (e.g., a presence-sensitive or touch-sensitive display) that displays a graphical keyboard and receives a user input, such as a touch gesture with the user's finger. The user may select an icon displayed by the presence-sensitive display, such as a delete key, and may provide a gesture to change the rate of deletion. For instance, after selecting the delete key, the user may provide the gesture of sliding the user's finger to the left or to the right. In such an example, the computing device may increase or decrease the rate of deletion based on the distance and direction that the user moved his or her finger to the left or to the right of the delete key with the gesture.

As another example, a user may provide a gesture to change the rate of execution of a function associated with an icon of a graphical keyboard displayed by a touch-sensitive display of the computing device by increasing or decreasing the amount of area of the touch-sensitive display that is in contact with an input unit (e.g., the user's finger). For instance, a user may select an icon of a graphical keyboard by touching the icon with his or her finger, and may provide the gesture of pressing down with increased force on the icon. The increased force may cause an increase in the amount of surface area on the touch-sensitive device that is in contact with the user's finger. In such an example, the computing device may change the execution rate of a function associated with the icon (e.g., the rate of deletion) based on the amount of surface area of the touch-sensitive display that is in contact with the user's finger.

In some examples, the computing device may output an indication of the execution rate. For instance, the computing device may cause the display to output an indicator bar, a numerical indication of the execution rate a function, a change in color of the selected icon, or other indications. In certain examples, the computing device may output an audible indication of the execution rate.

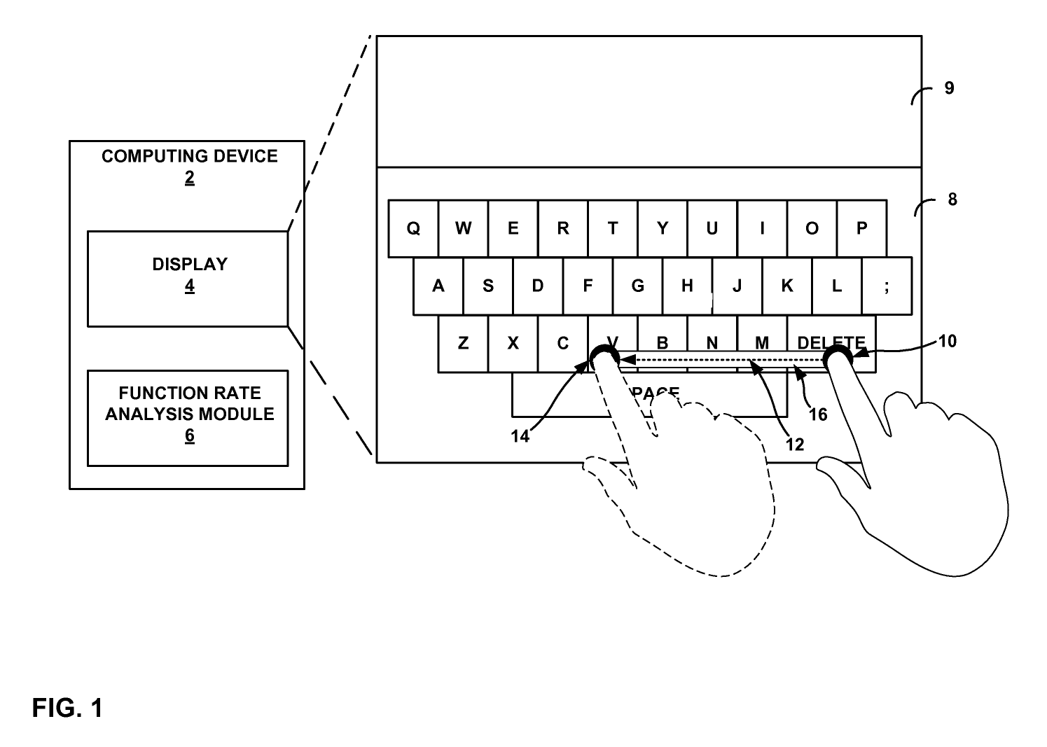

FIG. 1 is a block diagram illustrating an example computing device for reception of an indication of a user gesture and the performance of a function associated with a selected icon at an execution rate based on a rate of execution indicated by the user gesture, in accordance with one or more aspects of this disclosure. As illustrated in FIG. 1, computing device 2 may include display 4 and function rate analysis module 6. Examples of computing device 2 may include, but are not limited to, portable or mobile devices such as cellular phones, personal digital assistants (PDAs), tablet computers, laptop computers, portable gaming devices, portable media players, e-book readers, watches, as well as non-portable devices such as desktop computers.

Display 4 may be a liquid crystal display (LCD), e-ink, organic light emitting diode (OLED), or other display. Display 4 may present the content of computing device 2 to a user. For example, display 4 may display the output of applications executed on one or more processors of computing device 2 (e.g., word processing applications, web browsers, text messaging applications, email applications, and the like), confirmation messages, indications, or other functions that may need to be presented to a user. In some examples, display 4 may provide some or all of the functionality of a user interface of computing device 2. For instance, display 4 may be a presence-sensitive and/or a touch-sensitive interface that may allow a user to interact with computing device 2.

In the illustrated example of FIG. 1, computing device 2 may cause display 4 to display graphical keyboard 8. For example, display 4 may include a presentation portion 9 that displays text entered by a user, and a graphical keyboard 8 with which the user enters text that is displayed by presentation portion 9. Presentation portion 9 may display other icons or images in addition to the text entered by the user.

In some examples, a user may provide a user input to select one or more icons of graphical keyboard 8 by touching the area of display 4 that displays the icon of graphical keyboard 8. For instance, as illustrated, computing device 2 may receive an indication of a touch gesture with an input unit (e.g., the index finger of the user's right hand, in this example) at location 10 to select the delete key of graphical keyboard 8. In certain examples, as when display 4 includes a presence-sensitive display, a user input may be received when a user brings an input unit such as a finger, a stylus, a pen, and the like, within proximity of display 4 that is sufficiently close to enable display 4 to detect the presence of the input unit. As such, an indication of a touch gesture, such as the illustrated touch gesture at location 10, may be received by computing device 2 without actual physical contact between an input unit and display 4.

Computing device 2 may determine a function associated with the selected icon of graphical keyboard 8. As one example, computing device 2 may determine that the function of causing display 4 to display the character “A,” on presentation portion 9, is associated with the selection of the “A” icon displayed by graphical keyboard 8. As in the example of FIG. 1, computing device 2 may determine that the selection of the “DELETE” icon of graphical keyboard 8 is associated with the function of removing characters that are displayed by display 4 on presentation portion 9. For instance, a user may select the corresponding character icons of graphical keyboard 8 to cause display 4 to display the phrase, “My test phrase” on presentation portion 9. In such an example, a user may then select the “DELETE” icon of graphical keyboard 8 to cause computing device 2 to remove a character of the phrase on presentation portion 9. For instance, a user may select the “DELETE” icon three times to remove the last three characters of the example phrase (i.e., the “e”, “s”, and “a” characters) to cause display 4 to display the phrase, “My test phr” on presentation portion 9.

In some examples, function rate analysis module 6 may determine a base rate of execution of a function associated with a selected icon. As in the example of FIG. 1, a user may provide a touch gesture at location 10 to select the “DELETE” icon of graphical keyboard 8. Function rate analysis module 6 may determine a base rate of execution of the delete function associated with the “DELETE” icon, and may cause computing device 2 to repeatedly execute the delete function at the determined base rate of execution while the “DELETE” icon is selected. For instance, a user may select and hold (i.e., continue to select) the “DELETE” icon for a period of time, such as five seconds. Function rate analysis module 6 may determine the base rate of execution of the delete function as five characters per second, as one example. As such, function rate analysis module 6 may cause computing device 2 to execute the delete function to delete twenty-five characters (i.e., five characters per second for five seconds). As another example, function rate analysis module 6 may determine the base rate of execution to be one character per selection, in examples where the user does not continue to select a particular icon and, instead, taps the icon once.

In some examples, the base rate of execution may be pre-selected and computing device 2 may be preprogrammed with the base rate of execution. In these examples, function rate analysis module 6 may determine the base rate of execution based on the pre-selected base rate of execution. For instance, in these examples, in response to a selection of an icon on graphical keyboard 8, function rate analysis module 6 may determine the base rate of execution based on the pre-selected base rate of execution, and cause computing device 2 to execute the function at the base rate of execution.

In the example illustrated in FIG. 1, computing device 2 may receive an indication of rate gesture 12 that indicates a rate of execution of a function associated with the selected icon. For instance, the user may provide rate gesture 12 which may indicate a rate of execution of a function associate with the selected icon that is different than the base rate of execution. In the example of FIG. 1, rate gesture 12 includes the motion of the user's finger from location 10 to location 14 in a substantially horizontal path. However, aspects of this disclosure are not limited to such a horizontal motion. In some alternate examples, rate gesture 12 may include the motion of the user's finger in a substantially vertical path, a circular path, or some other path. In certain examples, rate gesture 12 may include gestures such as a touch gesture, or a repeated tapping of an input unit on display 4 at or near the selected icon, or at some other location on display 4, such as at a location of display 4 configured to receive rate gestures.

In examples where computing device 2 receives rate gesture 12, function rate analysis module 6 may determine the execution rate of the function associated with the icon selected by the touch gesture (e.g., the function associated with the “DELETE” icon selected with the touch gesture provided at location 10 in the example of FIG. 1) by determining a distance between location 10 and location 14, and determining the execution rate of the function based on the determined distance. For instance, function rate analysis module 6 may change the execution rate of the function associated with the selected icon (e.g., the delete function in the illustrated example) as compared to a base rate of execution proportionally to the distance between location 10 and location 14. In other words, rate gesture 12 may cause function analysis module 6 to determine a rate of execution of the selected function that may be different than the base rate of execution. In this manner, the example techniques described in this disclosure may allow the user to modify the rate at which computing device 2 executes a function associated with a selected icon (e.g., the rate of deletion in this example).

In certain examples, after receiving an indication of a first user gesture for the selection of an icon displayed by display 4 (e.g., a touch gesture at location 10), computing device 2 may cause display 4 to display an indication of a second user gesture that may be provided by the user to indicate a rate of execution of a function associated with the selected icon. For instance, in some examples, computing device 2 may cause display 4 to display the dashed line of FIG. 1 that illustrates rate gesture 12. In such an example, the displayed indication of the rate gesture may provide a visual cue to a user to indicate to the user that the rate gesture may be performed subsequent to the touch gesture to cause computing device 2 to change the execution rate of a function associated with the selected icon. In some examples, computing device 2 may cause display 4 to display other indications of a rate gestures that may be performed, such as displaying text that describes such gestures, audio output describing such gestures, and other similar indications.

In some examples, function rate analysis module 6 may change the execution rate of the function associated with the selected icon in a non-linear manner, such as by changing the execution rate proportionally to the square of the distance between location 10 and location 14. There may be different example techniques for computing device 2 to receive rate gesture 12, and examples of the manner in which function rate analysis module 6 may change the rate of execution. The example techniques of this disclosure are not limited to the above examples.

Function rate analysis module 6 may determine the execution rate of the function associated with the selected icon (e.g., the delete function in the example of FIG. 1) based on the direction of rate gesture 12. For example, in the example of FIG. 1, the user may provide rate gesture 12 in a right-to-left motion from location 10 to location 14. In such an example, function rate analysis module 6 may increase the execution rate of the function associated with the selected icon based on the right-to-left direction of rate gesture 12. Similarly, in examples where rate gesture 12 is provided in a left-to-right direction, function rate analysis module 6 may decrease the execution rate of the function associated with the selected icon.

Moreover, although rate gesture 12 is illustrated as moving the user's finger from location 10 to location 12, examples of rate gesture 12 are not so limited. In some examples, rate gesture 12 may include changes in the amount of surface area on display 4 that is in contact with the input unit. For instance, a user may press his or her finger with additional force at location 10. Due to the additional force, the amount of surface area on display 4 that is in contact with the user's finger may increase. In this example, function rate analysis module 6 may determine that the amount of surface area on display 4 that is in contact with the user's finger increased. In response, function rate analysis module 6 may increase the execution rate of the function associated with the selected icon.

In reverse, function rate analysis module 6 may also determine when there is decrease in the amount of surface area of display 4 that is contact with the input unit. In these situations, function rate analysis module 6 may decrease the execution rate of the function associated with the selection icon.

In some examples, computing device 2 may cause display 4 to display an indication of the execution rate of the function associated with the selected icon. For instance, as in FIG. 1, function rate analysis module 6 may determine an execution rate of the delete function based on the received indication of rate gesture 12, and may cause display 4 to display indicator bar 16. Indicator bar 16 may provide a visual indication of the execution rate of the function associated with the selected icon as determined by function rate analysis module 6 based on rate gesture 12. For instance, the length of indicator bar 16 may indicate the amount by which function rate analysis module 6 may determine the execution rate of the delete function.

Computing device 2 may execute the function associated with the selected icon at an execution rate based on the indicated rate of execution. For instance, as in the example of FIG. 1, computing device 2 may receive an indication of rate gesture 12 indicating a rate of execution of a delete function (i.e., a function associated with the selected “DELETE” icon). Function rate analysis module 6 may determine a change in the execution rate of the delete function indicated by rate gesture 12 based on the distance between location 10 and location 14 (e.g., a change in the rate of execution of the delete function proportional to the distance between location 10 and location 14). Similarly, function rate analysis module 6 may determine that the right-to-left direction of rate gesture 12 indicates an increase in the execution rate of the delete function. Function rate analysis module 6 may determine a base rate of execution of the delete function (e.g., one character per second), and may determine the execution rate of the delete function, such as by adding the indicated rate of execution to the base rate of execution. As such, computing device 2 may execute the delete function at the new execution rate determined based on the base rate of execution and the rate of execution as indicated by rate gesture 12.

In certain examples, computing device 2 may execute the function associated with the selected icon at the execution rate based on the indicated rate of execution in response to receiving a gesture indicating a rate of execution of the function (e.g., rate gesture 12). For instance, as in FIG. 1, computing device 2 may receive an indication of rate gesture 12 indicating a rate of execution of a delete function. In some examples, computing device 2 may execute the delete function in response to receiving the indication of rate gesture 12. As such, computing device 2 may increase the execution rate of the delete function as the user provides rate gesture 12. In other words, computing device 2 may continue to execute the delete function as the user slides his or her finger from location 10 to location 14, and may increase the rate of deletion as the distance between the user's finger and location 10 increases.

In some examples, when the user completes providing rate gesture 12, the execution rate of the selected icon may reset back to the base rate. In alternate examples, when the user completes providing rate gesture 12, the execution rate of the selected icon may reset back to the base rate after the user removes the input unit from display 4. In yet other alternate examples, after the user completes providing rate gesture 12, the execution rate of the selected icon may remain at its changed rate until the user provides another gesture to reset the execution rate back to the base rate of execution.

Furthermore, the change in the execution rate of the function associated with the selected icon may be limited to the function associated with the selected icon. For example, the user may select the “A” icon on graphical keyboard 8 and change the execution rate associated with the selection of the “A” icon utilizing the example techniques described above. In this example, the change in the execution rate associated with the selection of the “A” icon may not change the execution rate associated with any other icon of graphical keyboard 8. However, such aspects should not be considered limiting. In alternate examples, a change in the execution rate associated with one icon may change the execution rate associated with other icons as well.

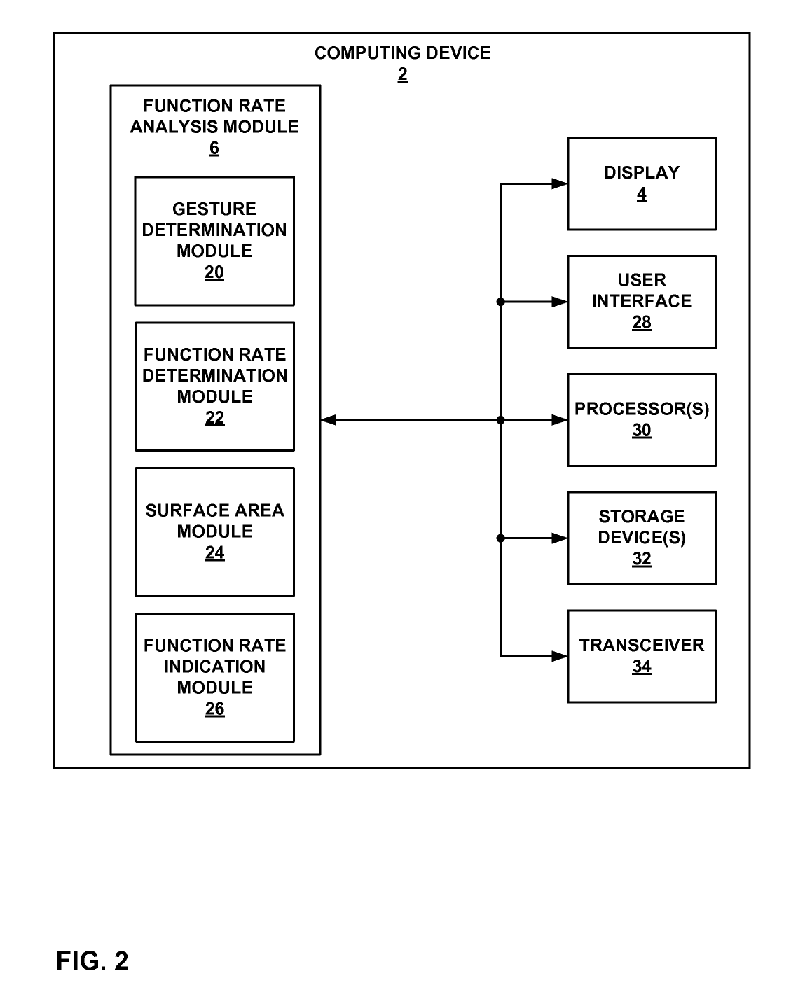

FIG. 2 is a block diagram illustrating an example computing device, in accordance with one or more aspects of this disclosure. As illustrated in FIG. 2, computing device 2 may include function rate analysis module 6, display 4, user interface 28, one or more processors 30, one or more storage devices 32, and transceiver 34. Function rate analysis module 6 may include gesture determination module 20, function rate determination module 22, surface area module 24, and function rate indication module 26.

Although shown as separate components in FIG. 2, in some examples, one or more of gesture determination module 20, function rate determination module 22, surface area module 24, and function rate indication module 26 may be part of the same module. In some examples, one or more of gesture determination module 20, function rate determination module 22, surface area module 24, function rate indication module 26, and one or more processors 30 may be formed in a common hardware unit. In some instances, one or more of gesture determination module 20, function rate determination module 22, surface area module 24, and function rate indication module 26 may be software and/or firmware units that are executed on or more processors 30.

In general, the modules of function rate analysis module 6 are presented separately for ease of description and illustration. However, such illustration and description should not be construed to imply that these modules of function rate analysis module 6 are necessarily separately implemented, but can be in some examples. Also, in some examples, one or more processors 30 may include function rate analysis module 6.

User interface 28 may allow a user of computing device 2 to interact with computing device 2. For example, user interface 28 may allow a user of computing device 2 to interact with computing device 2. Examples of user interface 28 may include, but are not limited to, a keypad embedded on computing device 2, a keyboard, a mouse, a roller ball, buttons, or other devices that allow a user to interact with computing device 2. In some examples, computing device 2 may not include user interface 28, and the user may interact with computing device 2 with display 4 (e.g., by providing various user gestures). In some examples, the user may interact with computing device 2 with display 4 or user interface 28.

As discussed above, display 4 may be a liquid crystal display (LCD), e-ink, organic light emitting diode (OLED), or other display that may present the content of computing device 2 to a user. Also as discussed above, display 4 may provide some or all of the functionality of user interface 28. For example, display 4 may be a presence-sensitive and/or a touch-sensitive interface that can allow a user to interact with computing device 2. For instance, display 4 may be a touch-sensitive interface that may display a graphical keyboard (e.g., graphical keyboard 8 of FIG. 1), may receive user inputs such as touch gestures to select one or more icons displayed by display 4 (e.g., one or more icons of graphical keyboard 8), and may receive user inputs such as gestures that indicate a rate of execution of a selected icon displayed by display 4 (e.g., rate gesture 12 of FIG. 1).

One or more processors 30 may include any one or more of a microprocessor, a controller, a digital signal processor (DSP), an application specific integrated circuit (ASIC), a field-programmable gate array (FPGA), or equivalent discrete or integrated logic circuitry. One or more processors 30 may be configured to implement functionality and/or process instructions for execution within computing device 2. For example, one or more processors 30 may be capable of processing instructions stored in one or more storage devices 32.

One or more storage devices 32 may include any volatile, non-volatile, magnetic, optical, or electrical media, such as a hard drive, random access memory (RAM), read-only memory (ROM), non-volatile RAM (NVRAM), electrically-erasable programmable ROM (EEPROM), flash memory, or any other digital media. Storage device 12 may, in some examples, be considered as a non-transitory storage medium. In certain examples, one or more storage devices 32 may be considered as a tangible storage medium. The terms “non-transitory” and “tangible” may indicate that the storage medium is not embodied in a carrier wave or a propagated signal. However, the term “non-transitory” should not be interpreted to mean that storage device 12 is non-movable. As one example, storage device 12 may be removed from local device 4, and moved to another device. As another example, a storage device, substantially similar to storage device 12, may be inserted into local device 4. A non-transitory storage medium may store data that can, over time, change (e.g., in RAM).

In some examples, one or more storage devices 32 may store one or more instructions that cause one or more processors 30, function rate analysis module 6, gesture determination module 20, function rate determination module 22, surface area module 24, and function rate indication module 26 to perform various functions ascribed to one or more processors 30, function rate analysis module 6, gesture determination module 20, function rate determination module 22, surface area module 24, and function rate indication module 26. One or more storage devices 32 may be considered as a computer-readable storage media comprising instructions that cause one or more processors 30, function rate analysis module 6, gesture determination module 20, function rate determination module 22, surface area module 24, and function rate indication module 26 to perform various functions.

Transceiver 34 may be configured to transmit data to and receive data from one or more remote devices, such as one or more servers or other devices. Transceiver 34 may support wireless or wired communication, and may include appropriate hardware and software to provide wireless or wired communication. For example, transceiver 34 may include one or more of an antenna, modulators, demodulators, amplifiers, and other circuitry to effectuate communication between computing device 2 and one or more remote devices.

Computing device 2 may include additional components not shown in FIG. 2 for clarity. For example, computing device 2 may include a battery to provide power to the components of computing device 2. As another example, computing device 2 may include a microphone and speaker to effectuate telephonic communication. Similarly, the components of computing device 2 may not be necessary in every example of computing device 2. For instance, in certain examples computing device 2 may not include transceiver 34.

In some examples, one or more processors 30 of computing device 2 may cause display 4 (e.g., a touch-sensitive and/or presence-sensitive interface) to display one or more selectable icons, such as one or more selectable icons of a graphical keyboard (e.g., graphical keyboard 8). In such examples, a user may provide a gesture to select an icon displayed by display 4, such as a touch gesture provided with an input unit. Examples of such input units may include, but are not limited to, a finger, a stylus, a pen, and the like. As one example, a user may provide a touch gesture to select an icon displayed by display 4 by touching an area of display 4 that corresponds to the displayed icon. In another example, as when display 4 includes a presence-sensitive interface, a user may provide a touch gesture to select an icon displayed by display 4 by bringing an input unit within proximity of an area of display 4 corresponding to the displayed icon such that the input unit is sufficiently close to display 4 to enable display 4 to detect the presence of the input unit.

Gesture determination module 20 may determine that a touch gesture has been received to select an icon displayed by display 4, and may determine a function associated with the selected icon. For instance, gesture determination module 20 may determine that the function associated with a space bar icon (e.g., the “SPACE” icon of graphical keyboard 8 of FIG. 1) is to cause display 4 to display a white space character on presentation portion 9, and may cause presentation portion 9 of display 4 to display a white space character in response to receiving one or more signals indicating that a touch gesture has been performed on display 4 to select the space bar icon of the graphical keyboard.

In some examples, gesture determination module 20 may determine that a gesture has been received that indicates a rate of execution of a function associated with the selected icon. For instance, as in the example of FIG. 1, gesture determination module 20 may determine that the user provided a touch gesture on location 10 and may also determine that the user provided rate gesture 12 of FIG. 1 to increase or decrease the rate of execution of the delete function. In certain examples, the rate gesture may include one or more signals that indicate the movement of an input unit from the selected icon (e.g., a first location 10) to a second, different location of display 4 (e.g., a second location1 14).

As one example, the rate gesture may include a continuous motion gesture, such that the gesture is received from a first location to a second location with substantially constant contact between the input unit and display 4. For instance, a user may provide a touch gesture with an input unit to select an icon, such as the delete key of a graphical keyboard displayed by display 4. The user may, in some examples, slide the input unit to the second location while maintaining contact between the input unit and display 4. In certain examples, as when display 4 includes a presence-sensitive interface, the substantially constant contact during the continuous motion gesture may include maintaining proximity between the input unit and display 4 that is sufficiently close to enable display 4 to detect the presence of the input unit throughout the continuous motion gesture.

As one example, the rate gesture may include a motion of an input unit that follows a substantially horizontal path. For instance, a user may provide a touch gesture with an input unit to select an icon displayed by display 4, and may move the input unit horizontally to the left or to the right. In other examples, the rate gesture may include a motion of an input unit that follows a non-horizontal path, such as a vertical path, a circular path, or other paths from one location to another.

In certain examples, gesture determination module 20 may determine that a rate gesture has been received that includes multiple touch gestures. For instance, a user may provide a touch gesture with an input unit to select a delete key of a graphical keyboard displayed by display 4. The user may provide multiple touch gestures at or near the delete key by quickly tapping the delete key with the input unit to indicate an increased rate of execution of the delete function. Gesture determination module 20 may determine that a rate gesture has been received when gesture determination module 20 receives one or more signals indicating that multiple touch gestures have been received at or near the selected icon on display 4 within a threshold amount of time.

In some examples, gesture determination module 20 may determine that a rate gesture has been received when a touch gesture is received at a location of display 4 configured to receive rate gestures. For example, computing device 2 may cause display 4 to display a graphical keyboard. In addition, computing device 2 may cause display 4 to display one or more areas, such as one or more buttons (as part of the graphical keyboard or separate from the graphical keyboard) that are configured to receive rate gestures. In such an example, a user may provide a touch gesture with an input unit to select an icon, such as a space bar icon of the graphical keyboard. The user may then provide a touch gesture at a location of display 4 configured to receive rate gestures, such as at a button displayed by display 4.

In certain examples, gesture determination module 20 may determine that a rate gesture has been received when a touch gesture is received at one or more of the locations of display 4 that are configured to receive rate gestures within a threshold amount of time after a touch gesture has been received to select an icon displayed by display 4. For instance, gesture determination module 20 may determine that if a touch gesture received at one or more of the locations configured to receive rate gestures has not been received within a threshold amount of time after a touch gesture was received to select an icon (e.g., one second), then no rate gesture has been received. In contrast, gesture determination module 20 may determine that if a touch gesture is received at one or more of the locations configured to receive rate gestures within a threshold amount of time after a touch gesture was received to select an icon (e.g., one second), then a rate gesture has been received.

In some examples, gesture determination module 20 may determine that a rate gesture has been received based on a change in the amount of surface area of display 4 that is in contact with an input unit (e.g., a user's finger). For instance, display 4 may include a touch-sensitive interface. A user may provide a touch gesture with his or her finger to select an icon displayed by display 4 by touching an area of display 4 that corresponds to the displayed icon. The user may then provide a gesture that indicates a rate of execution of a function associated with the icon by pressing down on display 4 with his or her finger. Such an increase in force may cause the surface area of the touch-sensitive display that is in contact with the user's finger to increase.

Gesture determination module 20 may receive one or more signals indicating the surface area of the touch-sensitive display that is in contact with an input unit (e.g., the user's finger), and may cause surface area module 24 to determine a surface area of a portion of the touch-sensitive display that is in contact with the input unit. In some examples, display 4 may indicate a radius of contact area between the input unit and display 4. For instance, the contact area may be an area of the touch-sensitive display where the detected capacitance of the touch-sensitive display changes responsive to the surface area of the input unit (e.g., a finger). In such examples, surface area module 24 may determine the surface area of the portion of display 4 that is in contact with the input unit using the radius indicated by display 4. In certain examples, display 4 may indicate a number of pixels or other units of known area of display 4 that are in contact with the input unit. Surface area module 24 may determine the surface area of the portion of display 4 that is in contact with the input unit, such as by summing the number of units of known area.

Gesture determination module 20 may cause surface area module 24 to determine a change in surface area of the portion of display 4 that is in contact with the input unit. Gesture determination module 20 may compare the detected change in the surface area of the portion of display 4 that is in contact with the input unit to a threshold value. In some examples, if the change in the surface area is less than a threshold value, gesture determination module 20 may determine that a rate gesture has not been provided. For instance, a user may rest an input unit on an icon displayed by display 4 after providing a touch gesture to select the icon. However, the user may unconsciously increase or decrease the force applied to the input unit while resting the input unit on display 4 without intending to provide a rate gesture. By comparing the determined change in surface area to a threshold value to determine if a rate gesture has been received, gesture determination module 20 may minimize the occurrences of unintended rate gestures.

In certain examples, gesture determination module 20 may determine that a rate gesture has been received when the determined change in surface area is greater than a threshold value. The threshold value may include an absolute change in surface area (e.g., a change of 2 square millimeters), a percentage of change in surface area (e.g., a ten percent change in surface area), or other types of measurements that can detect a relative change in surface area.

In response to receiving one or more signals indicating that a rate gesture has been performed on display 4, gesture determination module 20 may cause function rate determination module 22 to determine the rate of execution of a function associated with the selected icon. As one example, gesture determination module 20 may determine that a rate gesture has been provided that includes a motion of an input unit from a first location of display 4 to a second location of display 4. In such an example, function rate determination module 22 may determine a distance between the first location and the second location, and may determine the execution rate of a function associated with the selected icon based on the determined distance. In some examples, function rate determination module 22 may increase or decrease the execution rate of the function associated with the selected icon proportionally to the determined distance. In other examples, function rate determination module 22 may increase or decrease the execution rate of the function in a non-linear manner with respect to the determined distance, such as proportionally to the square of the distance, proportionally to the natural logarithm of the distance, or any other such manner.

As an example, the selected icon may be a delete icon of a graphical keyboard displayed by display 4. Function determination module 22 may obtain a base rate of execution of the delete function (i.e., the function associated with the delete icon), such as by obtaining the base rate of execution from an application executing on one or more processors 30. For instance, the base rate of execution of the delete function may be to delete one character per second while the delete icon is selected. Function rate determination module 22 may determine a change in the execution rate of the delete function relative to the obtained base rate of execution based on the determined distance between the first and second locations of the received rate gesture. For instance, function rate determination module 22 may add the determined change in the execution rate to the base rate of execution or subtract the determined change in the execution rate from the base rate of execution to determine the execution rate of the function.

In certain examples, function rate determination module 22 may determine the change in execution rate based on a direction of the motion of the input unit during the received rate gesture. For instance, function rate determination module 22 may add the determined change in execution rate to the base rate of execution when the rate gesture is received with a right-to-left direction. Similarly, function rate determination module 22 may subtract the determined change in execution rate from the base rate of execution when the rate gesture is received with a left-to-right direction.

However, such techniques should not be considered limited to the above directional examples. For instance, function rate determination module 22 may, in some examples, add the determined change in execution rate to the base rate of execution when the rate gesture is received with a left-to-right motion, and may subtract the determined change in execution rate from the base rate of execution when the rate gesture is received with a right-to-left direction.

Similarly, the rate gesture may be received with various directional paths, such as a vertical path, a circular path, and the like. Function rate determination module 22 may determine the change in execution rate based on the total distance traveled by the input unit during the rate gesture, or based on the linear distance between a first location at the start of the rate gesture and a second location at the end of the rate gesture. Function rate determination module 22 may increase or decrease the execution rate of the function associated with the selected icon based on the direction of the path of the rate gesture.

In some examples, gesture determination module 20 may determine that a rate gesture has been provided that includes a change in the amount of surface area of a portion of display 4 that is in contact with an input unit. For example, as discussed above, gesture determination module 20 may receive one or more signals, which it may possibly receive from display 4, indicating a change in the amount of surface area of a portion of display 4 that is in contact with an input unit, and may cause surface area module 24 to determine a first surface area of the portion of display 4 that is in contact with the input unit and to determine a second surface area of the portion of display 4 that is in contact with the input unit. Gesture determination module 20 may determine a surface area change between the first surface area and the second surface area, and may determine that a rate gesture has been received (e.g., when the first surface area change exceeds a threshold value).

Function rate determination module 24 may determine the execution rate of a function associated with the selected icon based on the determined change in surface area. For instance, function rate determination module 24 may obtain a base rate of execution of the function associated with the selected icon. Function rate determination module 24 may determine a change in execution rate relative to the base rate based on the determined surface area change. For instance, function rate determination module 24 may determine the change in execution rate as proportional to the change in surface area, as proportional to the square of the change in surface area, and the like.

In some examples, function rate determination module 24 may add the determined change in execution rate to the base rate to determine the execution rate of the function when the change in surface area is greater than zero. Similarly, function rate determination module 24 may subtract the determined change in execution rate from the base rate to determine the execution rate of the function when the change in surface area is less than zero.

Computing device 2 may execute the function associated with the selected icon at an execution rate based on the rate of execution indicated by the received rate gesture as determined by function rate determination module 24. In some examples, computing device 2 may execute the function associated with the selected icon at a rate that is substantially similar to the rate of execution indicated by the received rate gesture.

As one example, one or more processors 30 of computing device 2 may execute the function associated with the selected icon at the execution rate based on the indicated rate of execution in response to receiving a rate gesture. For instance, computing device 2 may execute the function associated with the selected icon while receiving the rate gesture, and may execute the function at an execution rate based on the rate of execution as indicated by the rate gesture.

In certain examples, one or more processors 30 of computing device 2 may execute the function associated with the selected icon at the execution rate based on the indicated rate of execution (e.g., the sum of a base rate of execution and a change in execution rate as indicated by a distance between a first and second location of a rate gesture) in response to a subsequently received gesture for the selection of the icon associated with the function. As an example, computing device 2 may receive an indication of a first gesture for the selection of a “DELETE” icon of a graphical keyboard. Computing device 2 may receive an indication of a second gesture (e.g., rate gesture 12 of FIG. 1) indicating a rate of execution of a delete function associated with the “DELETE” icon. Computing device 2 may determine an execution rate of the delete function based on the rate of execution as indicated by the second gesture (i.e., the rate gesture). Computing device 2 may, in certain examples, receive an indication of a third gesture, subsequent to and separate from the indication of the first gesture for the selection of the “DELETE” icon and the indication of the second gesture indicating the rate of execution of the delete function associated with the “DELETE” icon. In some examples, in response to receiving the indication of the third gesture for the selection of the “DELETE” icon, computing device 2 may execute the delete function associated with the “DELETE” icon at an execution rate based on the rate of execution indicated by the indication of the second gesture (i.e., the previously received rate gesture). In other examples, in response to receiving the indication of the third gesture for the selection of the “DELETE” icon, computing device 2 may execute the delete function associated with the “DELETE” icon at a base rate of execution, as determined irrespective of the indication of the second gesture indicating the rate of execution of the delete function.

In certain examples, function rate indication module 26 may cause computing device 2 to output an indication of the execution rate of the function associated with the selected icon. As one example, function rate indication module 26 may cause display 4 to output a visual indication of the execution rate of the function. For example, as in the example of FIG. 1, function rate indication module 26 may cause display 4 to output an indicator bar that indicates the execution rate of the function. In certain examples, function rate indication module 26 may cause display 4 to output one or more visual indications of the execution rate of the function, such as a textual or numeral indication of the execution rate, a change in color of a cursor, a change in color of the selected icon, or a movement of the selected icon that follows a movement of the input unit. For instance, function rate indication module 26 may cause display 4 to output a numerical indicator that indicates the absolute execution rate of the function. In another example, function rate indication module 26 may cause display 4 to output a numerical indicator that indicates a relative execution rate of the function (e.g., a scale from zero to one hundred, with the value zero indicating no change in execution rate and the value one hundred indicating a maximum execution rate of the function).

In some examples, function rate indication module 26 may cause display 4 to output a visual indication of the execution rate including a change in color of the selected icon. For instance, the selected icon may be a delete key of a graphical keyboard displayed by display 4. Function rate indication module 26 may cause display 4 to change the color of the delete key through a color spectrum to indicate the execution rate of the delete function (e.g., from white indicating no change in the execution rate to black indicating a maximum execution rate of the function, with darker shades of grey indicating a greater execution rate).

In certain examples, function rate indication module 26 may cause computing device 2 to output an audible indication of the execution rate. For example, computing device 2 may include a speaker device configured to provide audio output. As one example, function rate indication module 26 may cause computing device 2 to output a tone of constant pitch, but may vary the volume of the tone to indicate the execution rate of the function. For instance, function rate indication module 26 may cause computing device 2 to output a tone with a greater volume when the execution rate of the function increases and to output the tone with a decreased volume when the execution rate of the function decreases. Similarly, function rate indication module 26 may cause computing device 2 to output a tone of constant volume, but may vary the pitch of the tone to indicate the execution rate of the function (e.g., an increased pitch indicating an increased execution rate of the function and a decreased pitch indicating a decreased execution rate of the function).

In certain examples, after receiving an indication of a first user gesture for the selection of an icon displayed by display 4 (e.g., a touch gesture), function rate indication module 26 may cause display 4 to display an indication of a second user gesture that may be provided by the user to indicate a rate of execution of a function associated with the selected icon (e.g., a rate gesture). For instance, function rate indication module 26 may cause display 4 to display a horizontal or vertical line, indicating that the user may provide a rate gesture to cause computing device 2 to change the execution rate of a function associated with the selected icon. For instance, a user may provide a touch gesture to select a “DELETE” icon of a graphical keyboard displayed by display 4. In such an example, function rate indication module 26 may cause display 4 to display a horizontal line indicating that the user may provide a sliding gesture in a substantially horizontal path to cause computing device 2 to increase or decrease the rate of execution of the delete function (i.e., the function associated with the selected “DELETE” icon).

In another example, function rate indication module 26 may cause display 4 to display a plus sign (e.g., above the selected icon) and a minus sign (e.g., below the selected icon). In such an example, the displayed visual cues may indicate to a user that a rate gesture may be provided to cause computing device 2 to change the execution rate of the selected icon by sliding the input unit vertically (e.g., toward the plus sign to increase the rate of execution of the function, or toward the minus sign to decrease the rate of execution of the function). In some examples, function rate indication module 26 may cause display 4 to display an indication, such as a textual description of a rate gesture that may be provided to cause computing device 2 to change the execution rate of a function associated with the selected icon. As one example, after receiving an indication of a touch gesture to select an icon displayed by display 4, function rate indication module 26 may cause display 4 to display the text “Drag left to increase rate. Drag right to decrease rate.” In certain examples, function rate indication module 26 may cause a speaker device of computing device 2 to output an audio description of rate gestures that may be provided. For instance, function rate indication module 26 may cause a speaker device of computing device 2 to provide the audio output, “drag left or right to change rate.”

There may be different example techniques for function rate indication module 26 to cause computing device 2 to output an indication of the execution rate of the function. Similarly, there may different example techniques for function rate indication module 26 to cause computing device 2 to output an indication of a second user gesture that may be provided to cause computing device 2 to change the execution rate of a selected icon. The examples of this disclosure are not limited to the above examples.

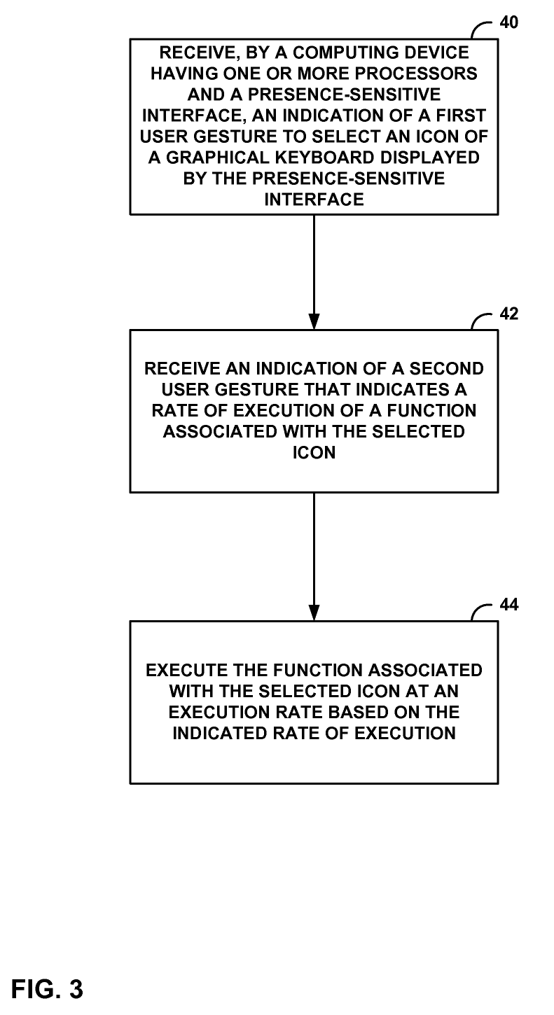

FIG. 3 is a flow chart illustrating an example operation of a computing device, in accordance with one or more aspects of this disclosure. For purposes of illustration only, the example operation is described below within the context of computing device 2 of FIG. 1 and FIG. 2. An indication of a first gesture to select an icon of a graphical keyboard displayed by a presence-sensitive interface may be received by the computing device having one or more processors and the presence-sensitive interface (40). For example, display 4 may include a presence-sensitive interface. Computing device 2 may cause display 4 to display one or more icons, such as icons of a graphical keyboard. A user may provide a gesture, such as a touch gesture with an input unit (e.g., a finger, pen, stylus, and the like) to select an icon displayed by display 4. For instance, a user may touch, with the input unit, an area of display 4 that corresponds to the displayed icon. In other examples, a user may bring the input unit within proximity of an area of display 4 that corresponds to the displayed icon, such that the input unit is sufficiently close to enable display 4 to detect the presence of the input unit.

An indication of a second user gesture that indicates a rate of execution of a function associated with the selected icon may be received (42). As one example, the selected icon may be a delete key of a graphical keyboard displayed by display 4. A user may provide the gesture of sliding an input unit from the delete icon to a second location on display 4. Gesture determination module 20 may receive one or more signals (e.g., from display 4 or some intervening module) indicating that the gesture of sliding the input unit from the delete icon to the second location of display 4 has been received. In response to receiving the indication of the user gesture, gesture determination module 20 may determine that a rate gesture has been received.

The function associated with the selected icon may be executed at an execution rate based on the indicated rate of execution (44). For example, function rate determination module 22 may determine that the received gesture indicates a change in execution rate of the function associated with the selected icon based on a determined distance between a first location of the gesture and a second location of the gesture. Computing device 2 may execute the function associated with the selected icon at an execution rate based on the indicated rate of execution as determined by function rate determination module 22.

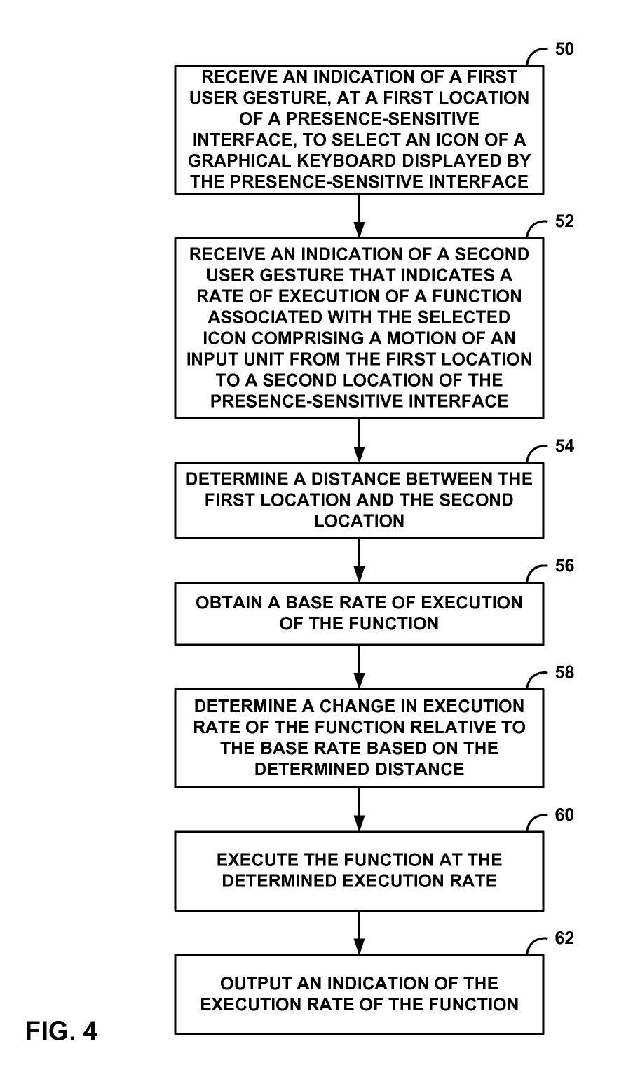

FIG. 4 is a flow chart illustrating another example operation of a computing device, in accordance with one or more aspects of this disclosure. For purposes of illustration only, the example operation is described below within the context of computing device 2 of FIG. 1 and FIG. 2. An indication of a first user gesture may be received at a first location of a presence-sensitive interface to select an icon of a graphical keyboard displayed by the presence-sensitive interface (50). For example, display 4 may include a presence-sensitive interface. One or more processors 30 of computing device 2 may cause display 4 to display a graphical keyboard. A user may provide a touch gesture with an input unit for the selection of an icon of the graphical keyboard. Gesture determination module 20 may receive one or more signals from display 4 indicating that the user has touched an area of display 4 that corresponds to an area of display 4 that displays an icon of the graphical keyboard. In response, gesture determination module 20 may determine that a touch gesture has been provided to select the icon of the graphical keyboard displayed by display 4.

An indication of a second user gesture that indicates a rate of execution of a function associated with the selected icon comprising a motion of an input unit from the first location to a second location of the presence-sensitive interface may be received (52). For example, gesture determination module 20 may receive one or more signals, potentially from display 4, indicating that a user has provided a touch gesture with an input unit to select a delete key icon of a graphical keyboard displayed by display 4. In certain examples, gesture determination module 20 may receive one or more signals (e.g., from display 4) indicating that the user has slid the input from the delete key to a second, different location of display 4. In some examples, gesture determination module 20 may receive one or more signals from display 4 indicating that a continuous motion gesture has been provided, such that the motion of the input unit from the first location to the second location has been received by display 4 with substantially constant contact between the input unit and display 4.

A distance between the first location and the second location may be determined (54). For instance, function rate determination module 22 may determine a linear distance between the first location and the second location. In other examples, function rate determination module 22 may determine the total distance traveled by the input device between the first location and the second location. A base rate of execution of the function may be obtained (56). As an example, the selected icon may be a delete icon of the graphical keyboard. In such an example, the function associated with the selected icon may be a delete function to remove characters that are displayed by display 4. Function rate determination module 22 may obtain a base rate of execution of the delete function, such as from an application actively executing on one or more processors 30. As an example, the base rate of execution of the delete function may be three characters per second.

A change in execution rate of the function relative to the base rate may be determined based on the determined distance (58). For example, function rate determination module 22 may determine a change in execution rate of the function as proportional to the distance between the first location and the second location. In another example, function rate determination module 22 may determine the change in execution rate proportionally to the square of the distance between the first location and the second location. In some examples, function rate determination module 22 may determine the change in execution rate of the function relative to the base rate by adding the determined change in execution rate to the base rate (e.g., when the motion of the gesture is received with a right-to-left motion). In other examples, function rate determination module 22 may determine the change in execution rate of the function relative to the base rate by subtracting the determined change in execution rate from the base rate (e.g., when the motion of the gesture is received with a left-to-right motion). The function may be executed at the determined execution rate (60). For instance, the function may be the delete function associated with the delete key icon of the displayed graphical keyboard. One or more processors 30 of computing device 2 may execute the delete function at the execution rate as determined by function rate determination module 22.

An indication of the execution rate of the function may be output (62). For example, function rate indication module 26 may cause display 4 to output a visual indication of the execution rate of the function. For instance, function rate indication module 26 may cause display 4 to output a numerical or textual indication of the execution rate. In certain examples, function rate indication module 26 may cause computing device 2 to output an audible indication of the execution rate of the function. For instance, the audible indication may include a tone with constant pitch and volume that varies proportionally to the execution rate of the function.

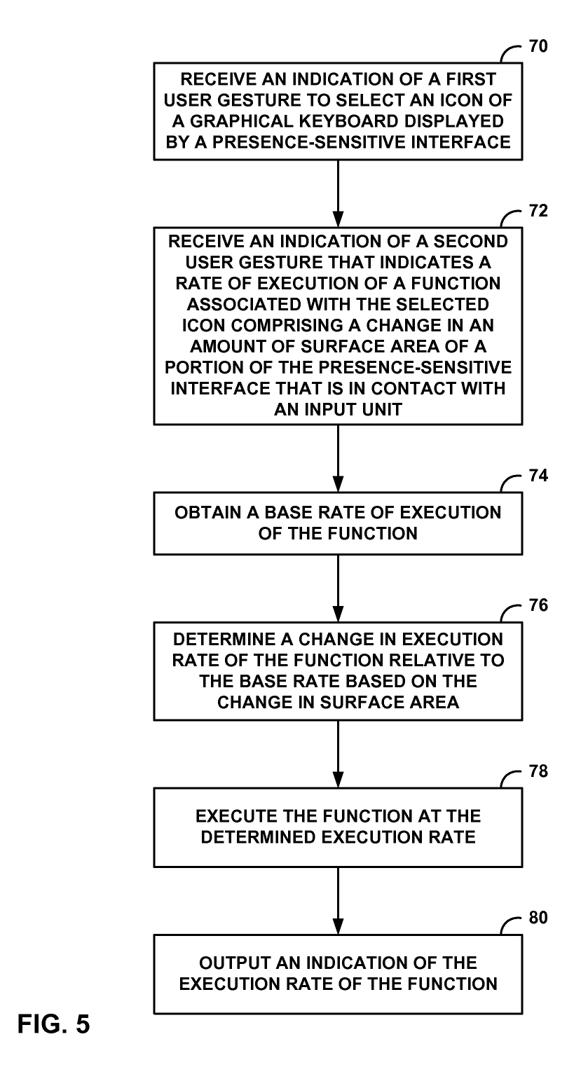

FIG. 5 is a flow chart illustrating another example operation of a computing device, in accordance with one or more aspects of this disclosure. For purposes of illustration only, the example operation is described below within the context of computing device 2 of FIG. 1 and FIG. 2. An indication of a first user gesture to select an icon of a graphical keyboard displayed by a presence-sensitive interface may be received (70). As one example, gesture determination module 20 may receive one or more signals from display 4 indicating that a user has touched an area of display 4 corresponding to an icon of a graphical keyboard displayed by display 4, and may determine that a touch gesture to select the icon has been received.

An indication of a second user gesture that indicates a rate of execution of a function associated with the selected icon comprising a change in an amount of surface area of a portion of the presence-sensitive interface that is in contact with an input unit may be received (72). As one example, gesture determination module 20 may receive one or more signals from display 4 indicating that a user has provided a touch gesture with an input unit to select an icon displayed by display 4. Gesture determination module 20 may cause surface area module 24 to determine a first surface area of a portion of the touch-sensitive display that is in contact with the input unit. In certain examples, the user may provide a second gesture to indicate a rate of execution of a function associated with the selected icon by increasing or decreasing the force applied to the input unit. The increased or decreased force applied to the input unit may increase or decrease the surface area of the input unit that is in contact with display 4. Gesture determination module 20 may receive one or more signals from display 4 indicating the change in surface area of display 4 that is in contact with the input unit, and may cause surface area module 24 to determine a second surface area of the portion of the touch-sensitive display that is in contact with the input unit. Gesture determination module 20 may determine a surface area change between the first surface area and the second surface area.

A base rate of execution of the function may be obtained (74). For example, the function associated with the selected icon may be a delete function to remove characters displayed by display 4. Function rate determination module 22 may obtain a base rate of execution of the delete function, such as from an application actively executing on one or more processors 30 (e.g., deleting one character per second).

A change in execution rate of the function relative to the base rate may be determined based on the change in surface area (76). For example, function rate determination module 22 may determine a change in execution rate of the function based on the change in surface area (e.g., proportionally to the change in surface area). In some examples, the change in execution rate of the function relative to the base rate may be determined by adding the determined change in execution rate to the base rate (e.g., when the change in surface area is greater than zero). In other examples, function rate determination module 22 may determine the change in execution rate of the function relative to the base rate by subtracting the determined change in execution rate from the base rate (e.g., when the change in surface area is less than zero).

The function may be executed at the determined execution rate (78). One or more processors 30 of computing device 2 may execute the function associated with the selected icon at the execution rate as determined by function rate determination module 22. An indication of the execution rate of the function may be output (80). Similar to block (62) of FIG. 4, function rate indication module 26 may cause display 4 to output one or more of a visual or audible indication of the execution rate of the function.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various aspects have been described in this disclosure. These and other aspects are within the scope of the following claims.

1. A method, performed by a computing device having one or more processors and a presence-sensitive interface, the method comprising:
receiving, by the computing device, an indication of a first user gesture to select an icon of a graphical keyboard displayed at the presence-sensitive interface of the computing device;
receiving, by the computing device, an indication of a second user gesture that indicates a rate of execution of a function associated with the selected icon,
wherein receiving the indication of the second user gesture comprises receiving an indication of a change in an amount of surface area of a portion of the presence-sensitive interface that is in contact with an input unit used to select the icon,
wherein receiving the indication of the change in the amount of surface area of the portion of the presence-sensitive interface that is in contact with the input unit comprises:
receiving an indication of a first surface area of the portion of the presence-sensitive interface that is in contact with the input unit at a first time, and
receiving an indication of a second surface area of the portion of the presence-sensitive interface that is in contact with the input unit at a second time,
wherein the input unit is in contact with the portion of the presence-sensitive interface between the first and second times;
determining a surface area change between the first surface area and the second surface area;
determining a rate based on the indicated rate of execution and on the determined surface area change; and
executing, by the computing device, the function associated with the selected icon at the determined rate based on the indicated rate of execution and on the determined surface area change.

2. The method of claim 1, wherein the rate based on the indicated rate of execution and on the determined surface area change is substantially similar to the indicated rate of execution.

3-11. (canceled)

12. The method of claim 1, further comprising:
obtaining a base rate of execution of the function associated with the selected icon,
wherein determining the rate based on the indicated rate of execution and on the determined surface area change comprises:
determining a change in an execution rate relative to the base rate based on the determined surface area change; and
adding the determined change in the execution rate to the base rate to determine the rate that is based on the indicated rate of execution.

13. The method of claim 12, wherein the determined surface area change between the first surface area and the second surface area is greater than zero.

14. The method of claim 1, further comprising:
obtaining a base rate of execution of the function associated with the selected icon,
wherein determining the rate based on the indicated rate of execution and on the determined surface area change comprises:
determining a change in an execution rate relative to the base rate based on the determined surface area change; and
subtracting the determined change in the execution rate from the base rate to determine the rate that is based on the indicated rate of execution.

15. The method of claim 14, wherein the determined surface area change between the first surface area and the second surface area is less than zero.

16. The method of claim 1, further comprising:
outputting, with the computing device, an indication of the rate that is based on the indicated rate of execution of the function associated with the selected icon.

17. The method of claim 16, wherein outputting the indication comprises outputting a visual indication of the rate that is based on the indicated rate of execution of the function.

18. The method of claim 16, wherein outputting the indication comprises outputting an audible indication of the rate that is based on the indicated rate of execution.

19. A computer-readable storage medium comprising instructions that, if executed by a computing device having one or more processors and a presence-sensitive interface, cause the computing device to perform a method, the method comprising:
receiving, by the computing device, an indication of a first user gesture to select an icon of a graphical keyboard displayed at the presence-sensitive interface of the computing device;
receiving, by the computing device, an indication of a second user gesture that indicates a rate of execution of a function associated with the selected icon,
wherein receiving the indication of the second user gesture comprises receiving an indication of a change in an amount of surface area of a portion of the presence-sensitive interface that is in contact with an input unit used to select the icon,
wherein receiving the indication of the change in the amount of surface area of the portion of the presence-sensitive interface that is in contact with the input unit comprises:
receiving an indication of a first surface area of the portion of the presence-sensitive interface that is in contact with the input unit at a first time, and
receiving an indication of a second surface area of the portion of the presence-sensitive interface that is in contact with the input unit at a second time,
wherein the input unit is in contact with the portion of the presence-sensitive interface between the first and second times;
determining a surface area change between the first surface area and the second surface area;
determining a rate based on the indicated rate of execution and on the determined surface area change; and
executing, by the computing device, the function associated with the selected icon at the determined rate based on the indicated rate of execution and on the determined surface area change.

20. A computing device, comprising:
one or more processors;
a presence-sensitive interface configured to:
display a graphical keyboard having one or more selectable icons;
receive an indication of a first user gesture to select an icon of the graphical keyboard displayed at the presence-sensitive interface; and
receive an indication of a second user gesture that indicates a rate of execution of a function associated with the selected icon,
wherein receiving the indication of the second user gesture comprises receiving an indication of a change in an amount of surface area of a portion of the presence-sensitive interface that is in contact with an input unit used to select the icon,
wherein receiving the indication of the change in the amount of surface area of the portion of the presence-sensitive interface that is in contact with the input unit comprises:
receiving an indication of a first surface area of the portion of the presence-sensitive interface that is in contact with the input unit at a first time, and
receiving an indication of a second surface area of the portion of the presence-sensitive interface that is in contact with the input unit at a second time,
wherein the input unit is in contact with the portion of the presence-sensitive interface between the first and second times; and
instructions, that if executed by the one or more processors, cause the computing device to:
determine a surface area change between the first surface area and the second surface area
determine a rate of the indicated rate of execution and on the determined surface area change; and
perform the function associated with the selected icon at the determined rate based on indicated rate of execution and on the determined surface area change.

21. The method of claim 1, wherein the first user gesture comprises a touch gesture.

22. The method of claim 1, wherein the second user gesture comprises an increase in the amount of surface area that is in contact by the input unit at the presence-sensitive interface.

23. The method of claim 1, wherein the second user gesture comprises a decrease in the amount of surface area that is in contact by the input unit at the presence-sensitive interface.

24. The method of claim 1, wherein the first user gesture to select the icon of the graphical keyboard comprises a touch gesture, and wherein the second user gesture comprises at least one of an increase in the amount of surface area that is in contact by the input unit at the presence-sensitive interface, and a decrease in the amount of surface area that is in contact by the input unit at the presence-sensitive interface.

25. The method of claim 1, further comprising:
determining, by the computing device, that a time difference between when the first user gesture is received and when the second user gesture is received is less than a threshold amount of time,
wherein executing the function comprises executing the function associated with the selected icon at the rate that is based on the indicated rate of execution and on the determined surface area change only when the determined time difference is less than the threshold amount of time.

26. The method of claim 1, further comprising:
determining, by the computing device, that the indication of the change in the amount of surface area of the portion of the presence-sensitive interface that is in contact with the input unit is greater than a threshold amount of surface area, and wherein executing the function associated with the selected icon at the rate that is based on the indicated rate of execution and on the determined surface area change comprises executing the function associated with the selected icon at the rate that is based on the indicated rate of execution and on the determined surface area change when the surface area of the portion of the presence-sensitive interface that is in contact with the input unit is greater than the threshold amount of surface area.
